(19) United States
(12) Patent Application Publication
(10) Pub. No.: US 2026/0132343 A1
(43) Pub. Date: May 14, 2026

(54) PROCESS FOR PRODUCTION OF A LOW-AROMATIC HYDROCARBON FROM PYROLYSIS OIL

(71) Applicant: Topsoe A/S, Kgs. Lyngby (DK)

(72) Inventors: Magnus Zingler STUMMANN, Copenhagen (DK); Stefan ANDERSEN, Værløse (DK); Jostein GABRIELSEN, Rødovre (DK); Rasmus Gottschalck EGEBERG, Fredensborg (DK)

(73) Assignee: Topsoe A/S, Kgs. Lyngby (DK)

(21) Appl. No.: 18/704,131

(22) PCT Filed: Oct. 26, 2022
(86) PCT No.: PCT/EP2022/079933

§ 371 Date: Apr. 24, 2024

(30) Foreign Application Priority Data
Oct. 26, 2021 (EP) 21204788.0

(51) Int. Cl. C10G 65/12; C10G 65/08

(52) U.S. Cl. CPC C10G 65/12; C10G 65/08; C10G 2300/1003; C10G 2300/1014; C10G 2300/301; C10G 2400/04

(57) ABSTRACT

A broad aspect of the present disclosure relates to a process for conversion of a feedstock containing at least 5 wt % aromatics, originating from thermal decomposition of solids, comprising the steps of directing the feedstock to contact a material catalytically active in hydrodeoxygenation under hydrodeoxygenation conditions in the presence of dihydrogen, to provide a deoxygenated intermediate, directing at least an amount of the deoxygenated intermediate to contact a material catalytically active in hydrodearomatization under hydrodearomatization conditions in the presence of dihydrogen, to provide an dearomatized intermediate.

This has the associated benefit of converting a feedstock such as pyrolysis oil to a product or an intermediate compatible with diesel fuel requirements with a minimal yield loss.

The present disclosure relates to a process and a process plant for conversion of a product of thermal decomposition of solids to a quality diesel fuel.

Products of thermal decomposition (for convenience pyrolysis oil), such as pyrolysis or hydrothermal liquefaction (HTL), of certain raw materials, such as lignocellulosic biomass or aromatic plastics (such as polystyrene) have a very high aromatic content such as from 30% and, up to 90% as well as high oxygen content from 5% to 50%. The conversion of pyrolysis oil to product traditionally involves a step of hydrotreatment, which include removal of oxygen, as well as other heteroatoms such as sulfur and nitrogen. After hydrotreatment the product normally has an aromatic content above 5%, often between 20-40% and even up to 70%, which has the consequence that the product may not fulfil diesel specifications for specific gravity (density).

The prior art, such as U.S. Pat. No. 7,578,927 teaches hydrocracking the hydrotreated intermediate to obtain final product suitable for use as a diesel component and a gasoline component. Hydrocracking will have the effect of changing the boiling point and also an effect of decreasing specific gravity by reducing the aromatic content by saturation and ring-opening. This adjustment of boiling point as well as the reduction specific gravity is desirable for product to be used as a diesel component. However, hydrocracking is related to a loss of yield, and removal of aromatics from gasoline components will cause a loss of octane number. Therefore, we propose an alternative process which does not decrease the diesel yield, and which may increase the value of the naphtha fraction, when used as a gasoline component, compared to a process employing hydrocracking.

The proposed alternative process involves hydrodearomatization of at least a fraction of the hydrotreated pyrolysis oil, possibly in combination with a separation scheme ensuring an optimal distribution of intermediates between different hydroprocessing schemes.

As used herein, the term “thermal decomposition” shall for convenience be used broadly for any decomposition process, in which a material is partially decomposed at elevated temperature (typically 250° C. to 800° C. or even 1000° C.), in the presence of substoichiometric amount of oxygen (including no oxygen). The product will typically be a combined liquid and gaseous stream, as well as an amount of solid char. The term shall be construed to include processes known as pyrolysis and hydrothermal liquefaction, both in the presence and absence of a catalyst.

For simplicity all products from thermal decomposition, such as pyrolysis and thermal liquefaction, will in the following be referred to as pyrolysis oil, irrespective of the nature of the originating process.

In the following the abbreviation ppmᵥ shall be used to signify volumetric parts per million, e.g. molar gas concentration.

In the following the abbreviation ppm_{w} shall be used to signify weight parts per million, e.g. the mass of sulfur atoms relative to the mass of a liquid hydrocarbon stream.

In the following the abbreviation wt % shall be used to signify weight percentage.

In the following the abbreviation vol % shall be used to signify volume percentage for a gas.

Where concentrations in the gas phase are given, they are, unless otherwise specified given as molar concentration.

Where concentrations in liquid or solid phase are given, they are, unless otherwise specified given as wt concentration.

The aromatic content of a liquid is in accordance with the art the total mass of molecules having at least one aromatic structure, relative to the total mass of all molecules in %.

One aspect of the present disclosure relates to a process for conversion of a feedstock containing at least 5 wt %, 15 wt % or 30 wt % aromatics, originating from thermal decomposition of solids, comprising the steps of directing the feedstock to contact a material catalytically active in hydrodeoxygenation under hydrodeoxygenation conditions in the presence of dihydrogen, to provide a deoxygenated intermediate, separating from the deoxygenated intermediate a deoxygenated distillate fraction boiling above 150° C. and directing at least an amount of the deoxygenated intermediate to contact a material catalytically active in hydrodearomatization under hydrodearomatization conditions in the presence of dihydrogen, to provide an dearomatized intermediate.

This has the associated benefit of converting a feedstock such as pyrolysis oil to a product or an intermediate compatible with diesel fuel requirements with a minimal yield loss, low reactor volume and without sacrificing aromatics in the naphtha fraction. The hydrodearomatization process may be configured for reduced the aromatic content to below 10 wt %, 5 wt % or 2 wt %, but above 0.1 wt %.

A further aspect of the present disclosure relates to a process for conversion of a feedstock containing at least 5 wt % aromatics, originating from thermal decomposition of solids, comprising the steps of directing the feedstock to contact a material catalytically active in hydrodeoxygenation under hydrodeoxygenation conditions in the presence of dihydrogen, to provide a deoxygenated intermediate and directing at least an amount of the deoxygenated intermediate to contact a material catalytically active in hydrodearomatization under hydrodearomatization conditions in the presence of dihydrogen, to provide an dearomatized intermediate.

In a further embodiment the process further comprises directing an unstabilized feedstock originating from thermal decomposition of solids, to contact a material catalytically active in hydrotreatment under pretreatment conditions in the presence of dihydrogen, to provide said composition originating from thermal decomposition of solids.

This has the associated benefit of stabilizing an unstabilized feedstock for further processing, minimizing the risk of pipe and reactor blocking and minimizing the risk of catalyst deactivation.

In a further embodiment at least an amount of the deoxygenated intermediate or the dearomatized intermediate is directed to contact a material catalytically active in hydrocracking under hydrocracking conditions in the presence of dihydrogen, to provide a hydrocracked intermediate.

This has the associated benefit of adjusting the boiling point of the intermediate products, while carrying out the majority of dearomatization in a process step with minimal yield loss.

In a further embodiment the process further comprises the step of separating the dearomatized intermediate, in at least a high boiling fraction of which at least 95 w/w % is boiling above 300° C., 350° C. or 370° C. and a vapor fraction and directing at least an amount of the high boiling fraction to contact the material catalytically active in hydrocracking under hydrocracking conditions in the presence of dihydrogen, to provide a hydrocracked intermediate.

This has the associated benefit of only directing the high boiling fraction to additional processing such as hydrocracking, and thus avoiding cracking to gases, saturation or ring-opening of naphtha aromatics, and thus maintaining a high yield of quality naphtha.

In a further embodiment the step of separating the intermediate involves stripping the deoxygenated intermediate with a stripping medium, at a temperature above 150° C., 180° C. or 200° C. and a difference from the hydrodeoxygenation conditions being less than 10 bar.

This has the associated benefit of providing an inexpensive and efficient separation of a fraction boiling in or above the diesel range.

In a further embodiment separating the intermediate further provides at least a heavy fraction boiling above a boiling point limit being 320° C., 340° C. or 360° C. and a middle distillate fraction boiling above 150° C., 180° C. or 200° C. and below the heavy fraction, wherein the amount of the deoxygenated intermediate directed to contact a material catalytically active in hydrodearomatization under hydrodearomatization conditions in the presence of dihydrogen comprises at least an amount of the middle distillate fraction.

This has the associated benefit of providing a middle distillate fraction suitable for use as a diesel component and without a need for consideration of the higher boiling fraction.

In a further embodiment at least an amount of the heavy fraction is directed to one or more of the following: to contact the material catalytically active in hydrocracking under hydrocracking conditions in the presence of dihydrogen thereby providing a hydrocracked heavy product, to said thermal decomposition process thereby providing a decomposed heavy product as part of said feedstock or unstabilized feedstock or to be withdrawn as a heavy product, optionally for further treatment.

This has the associated benefit of providing a treatment for reducing the molecular weight of the higher boiling fraction either by hydrocracking or by thermal decomposition, and thus produce additional product in the commercially valuable ranges.

In a further embodiment the mass of the heavy fraction is less than 15% of the feedstock.

This has the associated benefit of minimizing the requirement for hydrocracking a heavy fraction. The fraction may to some extent be controlled via the (upstream) pyrolysis conditions.

In a further embodiment one or more liquid recycle loops are established by directing an amount or a combination of amounts of middle distillate, dearomatized middle distillate, hydrocracked product, heavy fraction, hydrocracked intermediate, dearomatized intermediate or product stream to an upstream process step, such as the material catalytically active in hydrodearomatization, stabilization, the material catalytically active in hydrodeoxygenation, the material catalytically active in hydrodearomatization, the material catalytically active in hydrocracking or the step of separation.

This has the associated benefit of controlling the temperature in the upstream position, especially if the recycled flow is cooled or heated, and also to allow further reaction by the multiple passes over the catalytically active material.

In a further embodiment hydrodearomatization conditions involve a temperature in the interval 200-350° C., a pressure in the interval from 30 Bar to 150 Bar or even 200 Bar, and a liquid hourly space velocity (LHSV) in the interval 0.5-8.

This has the associated benefit of such process conditions being suitable for hydrogenation of aromatics, with a minimum of yield loss. The gas to oil ratio may be from 200 Nm³/m³ or 1000 Nm³/m³ to 2000 Nm³/m³ or 7000 Nm³/m³.

In a further embodiment said material catalytically active in hydrodearomatization comprises an active metal taken from the group comprising platinum, palladium, nickel, cobalt, tungsten and molybdenum, preferably one or more elemental noble metals such as platinum or palladium and a refractory support, preferably amorphous silica-alumina, alumina, silica, titania or molecular sieves, or combinations thereof.

This has the associated benefit of such catalytically active materials being stable and active in hydrodearomatization.

In a further embodiment the material catalytically active in hydrodearomatization has a higher hydrogenation activity than the material catalytically active in hydrodeoxygenation.

This has the associated benefit of effectively enabling hydrodearomatization at moderate temperatures. The effect is preferably obtained by the material catalytically active in hydrodearomatization comprising an elevated amount of active metals, such as from at least 0.1 wt %, at least 0.5 wt % or at least 1 wt %, to 3 wt % Pt or Pd noble metal or from at least 1 wt %, at least 5 wt % or at least 15 wt % to at most 20 wt %, at most 30 wt % or at most 50 wt % molybdenum or tungsten, promoted by an amount of nickel in the range from 0.1:1 Ni:Mo+W to 2:1 Ni:Mo+W (where the ratios designate molar ratios between the amount of Ni and the total amount of Mo and W) on a refractory oxidic support such as alumina, silica, titania or molecular sieves. The hydrodearomatization catalyst may also comprise only Ni in reduced form as active metal on a refractory support or may be an unsupported bulk catalyst comprising at least 50% sulfided Mo and/or W.

In a further embodiment the stream directed to contact the material catalytically active in hydrodearomatization is cooled prior to contacting the material catalytically active in hydrodearomatization.

This has the associated benefit of shifting the equilibrium further towards saturated ring structures especially if higher temperatures are required for deoxygenation of compounds such as di-phenols.

As hydrotreatment processes are controlled by multiple parameters, including pressure, temperature, space velocity, hydrogen partial pressure, feedstock composition, catalyst composition, nano-structure of the catalyst including surface area and pore size distribution, a functional definition of hydrodearomatization and other hydroprocessing processes is beneficial for the understanding of the present disclosure.

The combination of conditions, composition and structure of catalytically active materials and feedstocks makes it difficult to objectively define whether a given combination results in a specific process. The skilled person is aware of this and will from inspection of conditions and catalytically active material commonly understand the nature of the process, and his evaluation may be supported by simple and accessible experimental evaluations, which may be determined either from a specific feed or for a model compound, involving commonly available analytical equipment and laboratory facilities.

The extent of hydrotreatment may be determined by directing a feed to contact a catalytically active material under a set of conditions. The relative amount of heteroatoms removed, as calculated from the organically bound heteroatoms in the feed and the organically bound heteroatoms in the product, defines the extent of hydrotreatment for said combination of conditions and catalytically active material. This extent of hydrotreatment may be determined for oxygen—i.e. hydrodeoxygenation, for nitrogen—i.e. hydrodenitrogenation, sulfur—i.e. hydrodesulfurization and individual or total metals—i.e hydrodemetallization. In the excess of hydrogen, reaction to equilibrium would imply full conversion by hydrotreatment. Active hydrotreatment may imply conditions and catalytically active material under which the extent of hydrotreatment is at least 10%. The evaluation would however require that the molecular structures do not block conversion, e.g. by sterical hindrance, and therefore a specific experimental evaluation of hydrotreatment for a combination of catalytically active material, conditions and feedstocks is best made with a substituted alkane with no rings or a single ring structure.

The extent of hydrodearomatization may be determined by directing a feed to contact a catalytically active material under a set of conditions. The relative removed amount of total aromatics, calculated from the concentration of total aromatics in the product and the concentration of total aromatics in the feed, defines the extent of hydrodearomatization for said combination of conditions and catalytically active material. A relevant model compound may be 30% naphthalene in heptane, and the content of aromatics may be determined according to ASTM D-6591. Commonly full hydrodearomatization is not expected, since the reaction is limited by equilibrium, so more than 10% hydrodearomatization is considered active from an industrial perspective.

The extent of hydrogenation may be determined by directing a feed to contact a catalytically active material under a set of conditions. The relative amount of dihydrogen consumed will indicate the extent of hydrogenation, and in a comparison of two conditions/catalytically active materials the highest consumption of dihydrogen indicates the highest activity of hydrogenation.

The extent of hydrocracking may be determined by directing a feed to contact a catalytically active material under a set of conditions. The relative amount of material converted from boiling above a given temperature such as 370° C. to boiling below said given temperature 370° C., defines the extent of hydrocracking for said combination of conditions and catalytically active material. A relevant model compound would be a feed comprising a range of compounds, since with a single compound a realistic measure of the extent of hydrocracking is not obtained. In the excess of hydrogen, reaction to equilibrium would imply full conversion by hydrocracking, but in practice conditions are chosen as less severe such that conversion is limited, because this enables better control of the process. Increased total hydrocracking conversion may be obtained by recycling the heavy part of the product.

The extent of isomerization may be determined by directing a feed to contact a catalytically active material under a set of conditions. The relative amount of material converted from n-paraffins to branched paraffins with the same number of carbon atoms, defines the extent of isomerization for said combination of conditions and catalytically active material. A relevant model compound may be n-hexadecane. Alternatively a catalytically active material and conditions active in isomerization may also be determined by improved cold flow properties (i.e. a decrease of pour point or cloud point of at least 5° C.), with an increase in hydrocarbon hydrogen content of less than 0.5 wt %.

The term “dominating reaction” of a feedstock in the presence of a material catalytically active under active reaction conditions shall imply that under the specified set of conditions, the specific dominating reaction is the reaction having the highest extent of reaction, as determined above.

A combination of feedstock, catalytically active material and conditions is, unless otherwise stated, considered active for a given reaction if the extent of this reaction is above 10%. By this measure, more than one reaction may be active at the same combination of catalytically active material, conditions and feedstock.

Liquid products from thermal decomposition, such as pyrolysis and thermal liquefaction, have, especially from a global warming perspective, been considered an environmentally friendly replacement for fossil products, especially after hydrotreatment. The nature of these products (for simplicity pyrolysis oil, irrespective of the originating process) will commonly be that they are rich in oxygenates and possibly olefins. The nature of formation means that the products are not stabilized, and therefore, contrary to typical fossil raw feedstocks, they may be very reactive, demanding high amounts of hydrogen, releasing significant amounts of heat during reaction and furthermore having a high propensity towards polymerization. The release of heat may increase the polymerization further, and at elevated temperature catalysts may also be deactivated by coking.

The thermal decomposition process plant section providing the feedstock according to the present disclosure may be in the form of a fluidized bed, transported bed, or circulating fluid bed, as is well known in the art. This decomposition converts a pyrolysis feedstock into a solid (char), a high boiling liquid (tar) and fraction being gaseous at elevated temperatures. The gaseous fraction comprises a fraction condensable at standard temperature (pyrolysis oil or condensate, C5+ compounds) and a non-condensable fraction (pyrolysis gas, including pyrolysis off-gas). For instance, the thermal decomposition process plant section (the pyrolysis section) may comprise a pyrolizer unit (pyrolysis reactor), cyclone(s) to remove particulate solids such as char, and a cooling unit for thereby producing pyrolysis off-gas stream and said pyrolysis oil stream, i.e. condensed pyrolysis oil. The pyrolysis off-gas stream comprises light hydrocarbons e.g. C1-C4 hydrocarbons, H₂O, CO and CO₂. The pyrolysis oil stream from pyrolysis of biomass may also be referred to as bio-oil or bio-crude and is a liquid substance rich in blends of molecules usually consisting of more than two hundred different compounds mainly oxygenates such as acids, sugars, alcohols, phenols, guaiacols, syringols, aldehydes, ketones, furans, and other mixed oxygenates, resulting from the depolymerisation of the solids treated in pyrolysis. Typically, pyrolysis oil comprises condensate and tar.

For the purposes of the present invention, the pyrolysis section may be fast pyrolysis, also referred in the art as flash pyrolysis. Fast pyrolysis means the thermal decomposition of a solid renewable feedstock typically in the absence of oxygen, at temperatures typically in the range 350-650° C. e.g. about 500° C. and reaction times of 10 seconds or less, such as 5 seconds or less, e.g. about 2 sec. Fast pyrolysis may for instance be conducted by autothermal operation e.g. in a fluidized bed reactor. The latter is also referred to as autothermal pyrolysis and is characterized by employing air, optionally with an inert gas or recycle gas, as the fluidizing gas. Thereby, the partial oxidation of pyrolysis compounds being produced in the pyrolysis reactor (autothermal reactor) provides the energy for pyrolysis while at the same time improving heat transfer. In so-called catalytic fast pyrolysis, a catalyst may be used. An acid catalyst may be used to upgrade the pyrolysis vapors and can both be operated in an in-situ mode (the catalyst is located in the pyrolysis reactor) and an ex-situ mode (the catalyst is placed in a separate reactor). The use of a catalyst conveys the advantage of removing oxygen and thereby helping to stabilize the pyrolysis oil, thus making it easier to hydroprocess. In addition, increased selectivity towards desired pyrolysis oil compounds may be achieved.

In some cases, hydrogen is added to the catalytic pyrolysis which is called reactive catalytic fast pyrolysis. If the catalytic pyrolysis is conducted at a high hydrogen pressure, such as above 5 barg,) it is often called catalytic hydropyrolysis.

The pyrolysis stage may be fast pyrolysis which is conducted without the presence of a catalyst and hydrogen, i.e. the fast pyrolysis stage is not catalytic fast pyrolysis, hydropyrolysis or catalytic hydropyrolysis. This enables a much simpler and inexpensive process.

The thermal decomposition section may also be hydrothermal liquefaction. Hydrothermal liquefaction means the thermochemical conversion of biomass into liquid fuels by processing in a hot, pressurized water environment for sufficient time to break down the solid biopolymeric structure to mainly liquid components. Typical hydrothermal processing conditions are temperatures in the range of 250-375° C. and operating pressures in the range of 40-220 bar. This technology offers the advantage of operation of a lower temperature, higher energy efficiency and producing a product with a lower oxygen content compared to pyrolysis, e.g. fast pyrolysis.

Finally, other relevant thermal decomposition methods are intermediate or slow pyrolysis, in which the conditions involve a lower temperature and commonly higher residence times—these methods may also be known as carbonization or torrefaction. The major benefit of these thermal decomposition methods is a lower investment, but they may also have specific benefits for specific feedstocks or for specific product requirements, such a need for bio-char.

The conversion of oxygenates to hydrocarbons is a common process for production of renewable transportation fuels, but the reactivity and other specifics differ for different feedstocks. The pyrolysis oil typically comprises one or more oxygenates taken from the group consisting of ketones, aldehydes or alcohols, and may originate from thermal decomposition of plants, algae, animals, fish, vegetable oil refining, other biological sources, domestic waste, industrial biological waste like tall oil or black liquor as well as non-biological waste comprising suitable compositions, such as plastic fractions or rubber, including used tires, typically after a thermal and/or catalytic degradation process. When the feedstock is of biological origin, the feedstock and the product will be characterized by having a 14 C content above 0.5 parts per trillion of the total carbon content, but when the feedstock includes waste of fossil origin, such as plastic, this ratio may be different.

The production of hydrocarbon products typically requires one or more hydroprocessing steps which most commonly are; hydrotreatment for removing heteroatoms and saturating double bonds, hydroisomerization for adjusting hydrocarbon molecule structure and hydrocracking for reducing hydrocarbon molecular weight, and according to the present disclosure, hydrodearomatization is also of relevance.

During hydrotreatment, oxygenates are combined with an excess of hydrogen and react in hydrodeoxygenation processes as well as in decarboxylation and decarbonylation processes, where water, carbon dioxide and carbon monoxide are released from the oxygenates, and an amount of carbon dioxide is converted to carbon monoxide by the water/gas shift process. Typically, from 5 wt % or 10 wt % to 50 wt % of the oxygenate feedstock is oxygen, and thus a significant amount of the product stream will be water, carbon dioxide and carbon monoxide. In addition, an amount of light hydrocarbons may also be present in the product stream, depending on the nature of the feedstock and the side reactions occurring. Hydrotreatment may also involve extraction of other hetero-atoms, notably nitrogen and sulfur but possibly also halogens and silicon as well as saturation of double bonds. Especially the hydrotreatment of oxygenates is very reactive and exothermal, and moderate or low activity catalysts may be preferred to avoid excessive heat release and runaway reactions resulting in coke formation deactivating the catalyst. The catalyst activity is commonly controlled by only using low amounts of active metals and especially limiting the amount of promoting metals, such as nickel and cobalt.

Typically, hydrotreatment, such as deoxygenation and hydrogenation, involves directing the feedstock stream comprising oxygenates to contact a catalytically active material comprising sulfided molybdenum, or possibly tungsten, and/or nickel or cobalt, supported on a carrier comprising one or more refractory oxides, typically alumina, but possibly silica or titania. The support is typically amorphous. The catalytically active material may comprise further components, such as boron or phosphorous. The conditions are typically a temperature in the interval 250-400° C., a pressure in the interval 30-150 Bar, and a liquid hourly space velocity (LHSV) in the interval 0.1-2. The deoxygenation will involve a combination of hydrodeoxygenation producing water and if the oxygenates comprise carboxylic groups such as acids or esters, decarboxylation producing CO₂. The deoxygenation of carboxylic groups may proceed by hydrodeoxygenation or decarboxylation with a selectivity which, depending on conditions and the nature of the catalytically active material may vary from above 90% hydrodeoxygenation to above 90% decarboxylation. Deoxygenation by both routes is exothermal, and with the presence of a high amount of oxygen, the process may involve intermediate cooling e.g. by quenching with cold hydrogen, feed or product. The feedstock may preferably contain an amount of sulfur to maintain sulfidation of the metals, in order to maintain their activity. If the feedstock stream comprising oxygenates comprises less than 10, 100 or 500 ppm_{w} sulfur, a sulfide donor, such as dimethyldisulfide (DMDS) has typically been added to the feed.

If the unstabilized feedstock is highly reactive, a pre-treatment at moderate conditions may be relevant, to stabilize the feedstock. This may involve an inlet temperature as low as 80° C., 120° C. or 200° C., a pressure in the interval 3-15 MPa, and a liquid hourly space velocity (LHSV) in the interval 0.1-2 and a deliberate choice of less active catalytically active material, such as unpromoted molybdenum. Due to the reactive components and the exothermal nature thermal control may be relevant in this pre-treatment step.

Under the conditions in the HDO reactor, the equilibrium of the water gas shift process causes a conversion of CO₂ and H₂ to CO and H₂O. In the presence of the base metal catalyst an amount of methanation will take place, converting CO and H₂ to CH₄ and H₂O.

Depending on the structure of the feedstock, the deoxygenation process may provide a product rich in linear alkanes, having poor cold flow properties, and therefore the deoxygenation process may be combined with a hydroisomerization process, with the aim of improving the cold flow properties of products, and/or a hydrocracking process, with the main aim of adjusting the boiling point of products.

Typically, rearrangement of molecular structure by hydroisomerization involves directing an intermediate deoxygenated product stream feedstock to contact a material catalytically active in hydroisomerization comprising an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof). The catalytically active material may comprise further components, such as boron or phosphorous. The conditions are typically a temperature in the interval 250-350° C., a pressure in the interval 20-100 Bar, and a liquid hourly space velocity (LHSV) in the interval 0.5-8. Isomerization is substantially thermally neutral and hydrogen is typically not consumed in the isomerization reaction, although a minor amount of hydrocracking side reactions consuming hydrogen may occur. The active metal on the material catalytically active in isomerization may either be a sulfided base metal or a reduced noble metal. Noble metals are active at lower temperatures and the operation at lower temperature also means a lower extent of hydrocracking and related yield loss. If it is a noble metal, the deoxygenated feedstock is typically purified by gas/liquid separation section often involving a stripping process, which typically will use hydrogen as stripping medium, but other stripping media such as steam may also be used, to reduce the content of sulfur to below 1-10 ppm_{w}. If the active metal is a base metal, the feed to hydroisomerization may preferably contain an amount of sulfur to maintain sulfidation of the metals, in order to maintain their activity.

Hydrocracking will adjust the cold flow properties as well as the boiling point characteristics of a hydrocarbon mixture, by cracking large molecules into smaller. Typically, hydrocracking involves directing an intermediate feedstock to contact a material catalytically active in hydrocracking comprising an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The catalytically active material may comprise further components, such as boron or phosphorous. While this overall composition is similar to the material catalytically active isomerization the difference is typically the nature of the acidic support, which may be of a different structure (even amorphous silica-alumina) or have a different—typically higher-acidity e.g. due to silica:alumina ratio. The conditions are typically a temperature in the interval 250-400° C., which typically is higher temperatures than corresponding isomerization temperatures, a pressure in the interval 30-150 Bar, and a liquid hourly space velocity (LHSV) in the interval 0.5-8, optionally together with intermediate cooling by quenching with cold hydrogen, feed or product.

The composition of pyrolysis oils is defined by the raw material as well as the pyrolysis process. This means that the pyrolysis oil may contain only a moderate amount of high boiling material, and therefore the hydrocracking conditions may be moderate, and involve little or no recycle, which is beneficial, as the aromatic nature of pyrolysis oil could lead to extensive formation of polynuclear aromatics, which are known to be a challenge in refinery processes.

The material catalytically active in hydrodearomatization typically comprises an active metal (either promoted sulfided base metals such as tungsten and/or molybdenum promoted by nickel or cobalt, where the gas phase associated with the streams to hydrodearomatization preferably contains at least 50 ppmᵥ sulfur or—optionally after purification, by removal of e.g. hydrogen sulfide-noble metals such as platinum and/or palladium) and a refractory support (such as amorphous silica-alumina, alumina, silica, titania or molecular sieves, or combinations thereof). Hydrodearomatization is equilibrium controlled, with high temperatures favoring aromatics, and therefore noble metals are commonly preferred as the active metal, since they are active at lower temperatures, compared to base metals. The material catalytically active in hydrodearomatization typically comprises an elevated amount of active metals, such as from at least 0.1 wt %, at least 0.5 wt % or at least 1 wt %, to 3 wt % Pt or Pd noble metal or from at least 1 wt %, at least 5 wt % or at least 15 wt % to at most 20 wt %, at most 30 wt % or at most 50 wt % molybdenum or tungsten, promoted by an amount of nickel in the range from 0.1:1 Ni:Mo+W to 2:1 Ni:Mo+W (where the ratios designate molar ratios between the amount of Ni and the total amount of Mo and W) on a refractory oxidic support such as alumina, silica or titania. The hydrodearomatization catalyst may also comprise only Ni in reduced form as active metal on a refractory support or may be an unsupported bulk catalyst comprising at least 50% sulfided Mo and or W.

As hydrotreatment processes are controlled by multiple parameters, including pressure, temperature, space velocity, hydrogen partial pressure, feedstock composition, catalyst composition, nano-structure of the catalyst including surface area and pore size distribution, a functional definition of hydrodearomatization is beneficial for the understanding of the present disclosure. In accordance with the general understanding of the skilled person in the field, active in hydrodearomatization may be understood as a process in which at least 10% of the aromatic bonds are saturated, without substantial structural changes to the hydrocarbon structure. Preferably, without substantial structural changes to the hydrocarbon structure shall be understood as less than 10% of the carbon-carbon bonds in the feedstock being broken. While these definitions make sense from the perspective of chemical reactions, it may be preferred to employ definitions based on standard analytical methods in the field, as discussed above.

Typically, hydrodearomatization involves directing an intermediate product to contact a material catalytically active in hydrodearomatization. As mentioned the equilibrium between aromatics and saturated molecules shifts towards aromatics at elevated temperatures, so it is preferred that the temperature is moderate. The conditions are typically a temperature in the interval 200-350° C., a pressure in the interval from 30 Bar to 150 Bar or even 200 Bar, and a liquid hourly space velocity (LHSV) in the interval 0.5-8 and a gas to oil ratio which may be the ratio defined implicitly by the remaining hydrogen from the first hydrotreatment step, or it may be lower such as 200 to 2000 Nm³/m³. As mentioned, the commonly preferred active metal(s) on the material catalytically active in hydrodearomatization is often preferred to be noble metal(s), to benefit from low temperature equilibrium. According to the present disclosure, the intermediate downstream fractionation or stripping are typically sufficiently purified, so with hydrodearomatization in that position, the active metal(s) in the material catalytically active in hydrodearomatization may be noble metals. Base metal catalysts may also be used, and in this case the gas phase associated with the streams to hydrodearomatization preferably contains at least 50 ppmᵥ sulfur.

A hydroprocessed stream comprising hydrocarbons, excess hydrogen and inorganic molecules comprising heteroatoms must be separated in hydrocarbons and molecules—typically gases—comprising heteroatoms. To do this, the hydroprocessed stream is directed to a separation section, which for process scenarios relating to the treatment pyrolysis oil typically either will be between a base metal based hydrotreatment reactor and a noble metal based hydrodearomatization reactor, or if the material catalytically active in hydrodearomatization comprises base metals, downstream the hydrodearomatization reactor. The process may also comprise one or more other conversion steps, such as hydrocracking or hydroisomerization, and depending on the sequence of these steps and the catalytically active metals used, the skilled person will be aware of the possible positions for introducing a separation section with the purpose of withdrawing a recycle gas stream.

As the development of heat and the consumption of hydrogen is high in processes treating feedstocks rich in oxygenates, the gas to oil ratio in the hydroprocessing reactors is also very high compared to other hydroprocessing processes, such as from 1000 to 7000 Nm³/m³. This hydrogen gas may be used to control process temperatures, by stepwise injections of cooled gas. However, for the hydroprocessing processes with lower hydrogen consumption, including hydrodearomatization and hydrocracking, the gas to oil ratio may be lower, such as 200 to 2000 Nm³/m³.

The pyrolysis oil product streams may contain aromatic hydrocarbons, long linear hydrocarbons, gaseous hydrocarbons, water and to some extent carbon oxides, and in addition nitrogen in the hydrocarbonaceous feedstock will result in ammonia in the hydroprocessed stream. Added sulfur as well as any sulfur in the pyrolysis oil will be present as hydrogen sulfide in the hydroprocessed stream, and finally an excess amount of hydrogen will pass unreacted to the hydroprocessed stream. Intermediate separation steps may be required for optimal handling of this diverse mixture.

In addition, the necessity to combine 3 or 4 catalytically active materials for optimal conversion of pyrolysis oil into hydrocarbons naturally complicates the process layout, and the sequence of the materials must be considered carefully, especially concerning the presence of sulfur required for base metals and shunned for noble metals.

In the process layouts, recycle may be used for different purposes; gas recycle for efficient use of hydrogen, liquid recycle around the material catalytically active in hydrocracking to maximize the yield of the desired fraction and liquid recycle around the material catalytically active in hydrodeoxygenation to limit the temperature increase due to exothermal deoxygenation reactions as well as to limit the reaction rate of polymerization reactions for reactive oxygenates and other reactive compounds in the pyrolysis oil. The choice of recycle configuration will be related to different benefits, including process simplicity by minimizing the number of recycle loops, minimizing reactor volume and cost by choosing configurations with low recycle volumes, maximizing process reactivity control by high recycle volume and/or extensive cooling, and minimizing polymerization by high recycle volume.

Process configurations without recycle may also be beneficial due to simplicity and low cost, especially in the cases where the process volume is moderate.

As isomerization and hydrodearomatization may be carried out using a catalytically active material comprising noble metals, “sour gases”, including hydrogen sulfide, carbon dioxide and ammonia, are removed prior to these reactions.

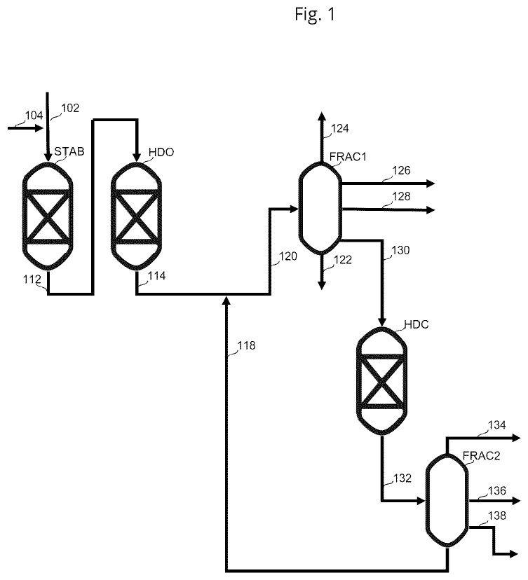

FIG. 1 shows a process for upgrading pyrolysis oil according to the prior art.

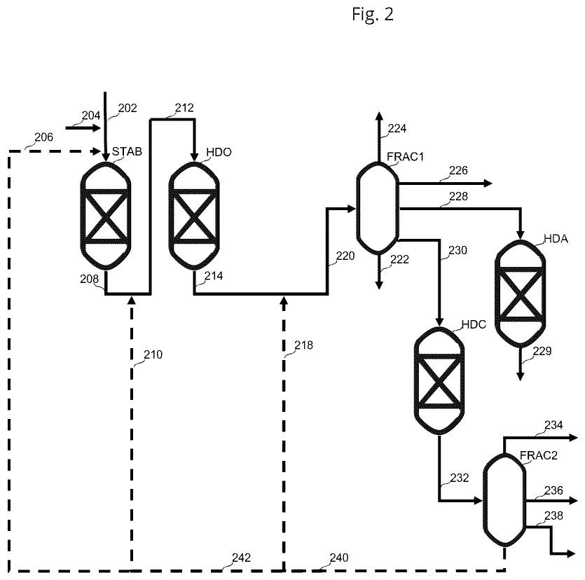

FIG. 2 shows a process for upgrading pyrolysis oil according to the present disclosure, employing hydrodearomatization of a stream boiling in the diesel range.

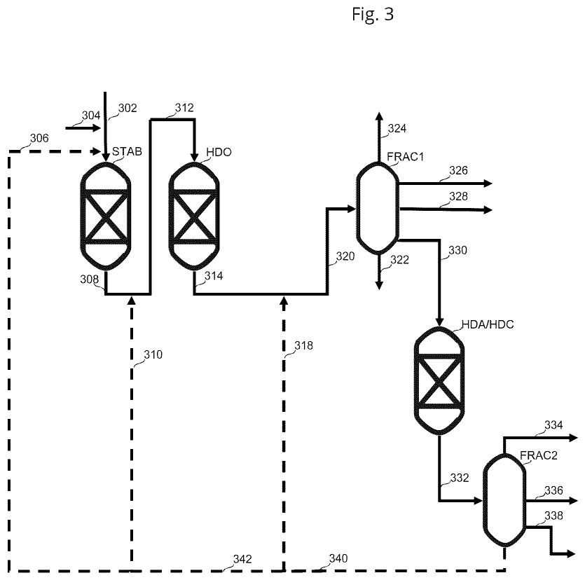

FIG. 3 shows a process for upgrading pyrolysis oil according to the present disclosure, employing hydrodearomatization and hydrocracking of a heavy stream boiling in the diesel range.

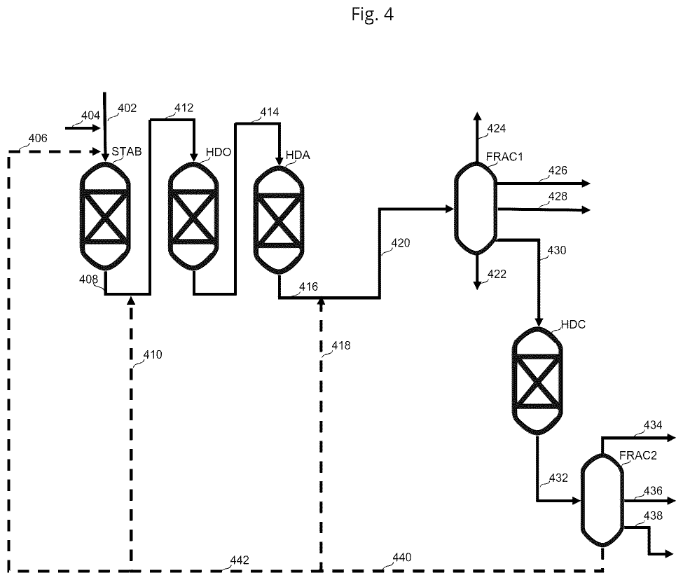

FIG. 4 shows a process for upgrading pyrolysis oil according to the present disclosure, employing hydrodearomatization of the full product stream and hydrocracking of a heavy stream.

The figures mainly illustrate the hydrocarbon flows of the process, and the skilled person will be aware that hydrogen addition, even though not shown, will be required in the process. For economical reason hydrogen rich gas stream(s) may also be recycled, optionally after purification. In a similar manner, process conditions such as temperature and pressure may also be relevant to control, and this may be done by equipment not shown, such as air coolers, fired heaters and heat exchangers, as well as pumps and compressors. The skilled person will also be aware of other elements in the process not shown in the figures, with practical relevance for the process but with limited specific relevance for the invention, and furthermore specific configurations such as recycle streams may be shown, but alternative implementations may be possible with no detriment to the invention.

FIG. 1 shows a process layout in which a feedstock such as pyrolysis oil (102) is directed to a stabilization pre-treatment reactor (STAB) together with a hydrogen rich make up gas (104), to provide a stabilized pyrolysis oil (112) for feeding the hydrodeoxygenation reactor (HDO). A deoxygenated intermediate (114) is withdrawn and combined with an optional recycled heavy hydrocracked product (118) and directed to a first fractionator section (FRAC1), from which water (122), gases (124), and naphtha range product (126) as well as diesel range product (128) are withdrawn. Furthermore, a bottoms stream (130) is withdrawn and together with hydrogen (not shown) directed to a hydrocracking reactor (HDC), from which a hydrocracked product (132) is withdrawn. The hydrocracked product (132) is fractionated in a further fractionator (FRAC2), which here is a separate unit, but the process may also may be configured for integrated fractionation in a single fractionator system. From the further fractionator (FRAC2), gases (134), low boiling product (136) and high boiling product (138) is withdrawn, in addition to an amount of recycled heavy hydrocracked product (118). The recycled heavy hydrocracked product (118) is directed for fractionation and hydrocracking.

FIG. 2 shows a process layout in which a feedstock such as pyrolysis oil (202) is directed to a stabilization pre-treatment reactor (STAB) together with a hydrogen rich make up gas (204) and an optional recycle stream (206), to provide a stabilized pyrolysis oil (208), which here is combined with an optional recycle stream (210) to provide a stabilized stream (212) for feeding the hydrodeoxygenation reactor (HDO). A deoxygenated intermediate (214) is withdrawn and optionally combined with an amount of a recycled heavy hydrocracked product (218), before being directed as a stream for fractionation (220), which is directed to a first fractionator section (FRAC1), from which water (222), gases (224), naphtha range product (226), diesel range product (228) and a bottoms stream (230) is withdrawn. The diesel range product (228) is combined with hydrogen (not shown) and directed to a hydrodearomatization reactor (HDA) to provide a quality diesel range product (229). Furthermore, the bottoms stream (230) is together with hydrogen (not shown) directed to a hydrocracking reactor (HDC), from which a hydrocracked product (232) is withdrawn. The hydrocracked product (232) is fractionated in a further fractionator (FRAC2), which here is a separate unit, but the process may also may be configured for integrated fractionation in a single fractionator section. From the further fractionation section (FRAC2), gases (234), naphtha range product (236) and diesel range product (238) are withdrawn, in addition to an amount of recycled heavy hydrocracked product (240). The recycled heavy hydrocracked product (240) is split between a stream (218) directed directly for fractionation and hydrocracking and a recycle stream (242) to be directed for the stabilization reactor (STAB) and the hydrodeoxygenation reactor (HDO).

FIG. 3 shows a process layout in which a feedstock such as pyrolysis oil (302) is directed to a stabilization pre-treatment reactor (STAB) together with a hydrogen rich make up gas (304) and an optional recycle stream (306), to provide a stabilized pyrolysis oil (308), which here is combined with an optional recycle stream (310) to provide a stabilized stream (312) for feeding the hydrodeoxygenation reactor (HDO). A deoxygenated intermediate (314) is withdrawn and optionally combined with an amount of a recycled heavy hydrocracked product (318), before being directed as a stream for fractionation (320), which is directed to a first fractionator section (FRAC1), from which water (322), gases (324), naphtha range product (326) and diesel range product (328) is withdrawn. Furthermore, a bottoms stream (330) is withdrawn and together with hydrogen (not shown) directed to a combined hydrodearomatization and hydrocracking reactor (HDA/HDC), from which a hydroprocessed product (332) is withdrawn. The hydroprocessed product (332) is fractionated in a further fractionator (FRAC2), which here is a separate unit, but the process may also may be configured for integrated fractionation in a single fractionator section. From the further fractionation section (FRAC2), gases (334), naphtha range product (336) and diesel range product (338) are withdrawn, in addition to an amount of recycled heavy hydroprocessed product (340). The recycled heavy hydroprocessed product (340) is split between a stream (318) directed directly for fractionation and hydrocracking and a recycle stream (342) to be directed for the stabilization reactor (STAB) and the hydrodeoxygenation reactor (HDO).

FIG. 4 shows a process layout in which a feedstock such as pyrolysis oil (402) is directed to a stabilization pre-treatment reactor (STAB) together with a hydrogen rich make up gas (404) and an optional recycle stream (406), to provide a stabilized pyrolysis oil (408), which here is combined with an optional recycle stream (410) to provide a stabilized stream (412) for feeding the hydrodeoxygenation reactor (HDO). A deoxygenated intermediate (414) is withdrawn and cooled and directed to a hydrodearomatization reactor (HDA). The dearomatized product (416) is optionally directed to be combined with an amount of a recycled heavy hydrocracked product (418), before being directed as a stream for fractionation (420), which is directed to a first fractionator section (FRAC1), from which water (422), gases (424), naphtha range product (426) and diesel range product (428) is withdrawn. Furthermore, a bottoms stream (430) is withdrawn and together with hydrogen (not shown) directed to a hydrocracking reactor (HDC), from which a hydrocracked product (432) is withdrawn.

The hydrocracked product (432) is fractionated in a further fractionator (FRAC2), which here is a separate unit, but the process may also may be configured for integrated fractionation in a single fractionator section in which case the hydrocracked product (432) would be directed to be combined with the stream for fractionation (420). From the further fractionation section (FRAC2), gases (434), naphtha range product (436) and diesel range product (438) are withdrawn, in addition to an amount of recycled heavy hydrocracked product (440). The recycled heavy hydrocracked product (440) is split between a stream (418) directed directly for fractionation and hydrocracking and a recycle stream (442) to be directed for the stabilization reactor (STAB) and the hydrodeoxygenation reactor (HDO).

In the FIGS. 2,3 and 4, three recycle loops are illustrated, but depending on i.a. the nature of the feed and the desired products, only one or two of these may be preferred in practice.

Furthermore, cooling between reactors is not shown, but as mentioned above, especially if the streams contains refractive oxygenates such as di-phenols, elevated HDO temperatures may be required, and thus cooling prior to HDA may be relevant.

Especially the first fractionator in all figures may beneficially be replaced by a stripper, which, especially if operating at elevated temperature and pressure, will reduced operational cost, as no or minimal re-heating and re-pressurization downstream the stripper would be required.

### EXAMPLES

Processes according to the illustration in FIG. 1, FIG. 2, FIG. 3 and FIG. 4 are compared in the following.

All processes are carried out, assuming a stabilized feedstock according to Table 1, which is an example corresponding to a stabilized pyrolysis oil from fast pyrolysis of wood chips.

For simplicity, examples are shown assuming no recycle streams, and isothermal reactors, with results reported as mass streams (Ton/h) and streams are specified by the wt % of aromatics.

Table 2 compares two variants of the process according to the prior art shown in FIG. 1; either (Case 1) focusing on high yield or (Case 2) focusing on high diesel quality. Case 1 assumes directing 12 Ton/h to hydrocracking, whereas Case 2 assumes directing 18 Ton/h to hydrocracking. In Case 1 hydrocracking conditions are mild, thus leading to a high diesel yield of 21 ton/h with 36 wt % aromatics, thus the diesel is of a low quality and needs to be blended. In Case 2 most of the diesel fraction send to the HDC reactor which operates at higher conversion, thus leading to a diesel yield of 19 ton/h with an aromatic content of 26 wt %, thus better quality but lower yield than Case 1. The combined naphtha/diesel yield of Case 1 is 46 Ton/h vs. 45 Ton/h in Case 2.

Table 3 shows the mass flow and percentage of aromatics in key streams of FIG. 2-4. This shows that the concept shown in FIGS. 2 and 4 gives a diesel yield of 21 Ton/h, thus similar to the yield in FIG. 1 case 1, but with an aromatic concentration of 4.8 and 1.7 wt %, respectively. The diesel produced from the layout shown in FIGS. 2 and 4 are therefore of higher quality than the diesel produced in the layout shown in FIG. 1. Using the layout shown in FIG. 3 gives a diesel yield of 16 Ton/h with 1.5 wt % aromatics, furthermore 5.6 Ton/h kerosene is also produced. The Kerosene contains 28 wt % aromatics and can either be mixed with the diesel, blended to meet the specification or hydrotreated using a separate HDA reactor.

TABLE 1

| Property | Unit | Method | 112/212/312/412 |
|---|---|---|---|
| Aromatics | wt % | GC × GC-MS/FID | 70 |
| | | (area FID) | |
| Oxygen | wt % | Elemental analysis | 40 |
| Boiling point | | ASTM D7500 | |
| (° C.) | | | |
| IBP | ° C. | | 100 |
| 10 wt/wt % | ° C. | | 140 |
| 30 wt/wt % | ° C. | | 240 |
| 50 wt/wt % | ° C. | | 300 |
| 70 wt/wt % | ° C. | | 410 |
| 90 wt/wt % | ° C. | | 530 |
| FBP | ° C. | | 730 |

TABLE 2

| | FIG. 1 - case 1 | | | FIG. 1 - case 2 | | |
|---|---|---|---|---|---|---|
| Stream | Ton/h | % aro | SG | Ton/h | % aro | SG |
| 112 | 100 | 70 | 1.2 | 100 | 70 | 1.2 |
| 114 | 46 | 45 | 0.88 | 46 | 45 | 0.88 |
| 126 ^{(a)} | 21 | 25 | 0.82 | 21 | 25 | 0.82 |
| 128 ^{(b)} | 13 | 50 | 0.89 | 7.1 | 50 | 0.88 |
| 130 | 12 | 73 | 0.99 | 18 | 66 | 0.96 |
| 136 ^{(c)} | 3.9 | 12 | 0.75 | 5.7 | 11 | 0.75 |
| 138 ^{(d)} | 7.7 | 12 | 0.82 | 11 | 11 | 0.82 |
| Naphtha ^{(a+c)} | 25 | 23 | 0.81 | 27 | 22 | 0.80 |
| Diesel ^{(b+d)} | 21 | 36 | 0.86 | 19 | 26 | 0.84 |
| Kerosene | 0 | 0 | 0.00 | 0 | 0 | 0.00 |

TABLE 3

| | FIG. 2 | | | FIG. 3 | | | FIG. 4 | | |
|---|---|---|---|---|---|---|---|---|---|
| Stream | Ton/h | % aro | SG | Ton/h | % aro | SG | Ton/h | % aro | SG |
| 212/312/412 | 100 | 70 | 1.2 | 100 | 70 | 1.2 | 100 | 70 | 1.2 |
| 214/314/414 | 46 | 45 | 0.88 | 46 | 45 | 0.88 | 48 | 45 | 0.85 |
| 416 | 0 | 0 | 0.00 | 0 | 0 | 0.00 | 48 | 2.2 | 0.00 |
| 226/326/426^{(a)} | 21 | 25 | 0.82 | 19 | 22 | 0.81 | 21 | 1.5 | 0.81 |
| 229/328/428^{(b)} | 14 | 0.50 | 0.86 | 5.6 | 28 | 0.83 | 14 | 2.3 | 0.85 |
| 230/330/430 | 12 | 73 | 0.99 | 22 | 68 | 0.96 | 13 | 3.3 | 0.924 |
| 236/336/436^{(c)} | 3.9 | 12 | 0.75 | 4.7 | 1.5 | 0.75 | 3.9 | 0.55 | 0.75 |
| 238/338/438^{(d)} | 7.7 | 12 | 0.82 | 16 | 1.5 | 0.84 | 7.7 | 0.55 | 0.82 |
| Naphtha^{(a+c)} | 25 | 23 | 0.81 | 23 | 18 | 0.80 | 25 | 1.3 | 0.80 |
| Diesel^{(b+d)} | 21 | 4.8 | 0.84 | 16 | 1.5 | 0.84 | 21 | 1.7 | 0.84 |
| Kerosene | 0 | 0 | 0.00 | 5.6 | 28 | 0.83 | 0 | 0 | 0.00 |

1. A process for conversion of a feedstock containing at least 5 wt %, originating from thermal decomposition of solids, comprising the steps of
a. directing the feedstock to contact a material catalytically active in hydrodeoxygenation under hydrodeoxygenation conditions in the presence of dihydrogen, to provide a deoxygenated intermediate,
b. separating from the deoxygenated intermediate a deoxygenated distillate fraction boiling above 150° C. and
c. directing at least an amount of the deoxygenated distillate fraction to contact a material catalytically active in hydrodearomatization under hydrodearomatization conditions in the presence of dihydrogen, to provide an dearomatized intermediate.

2. A process according to claim 1, further comprising directing a unstabilized feedstock originating from thermal decomposition of solids, to contact a material catalytically active in hydrotreatment under pretreatment conditions in the presence of dihydrogen, to provide said composition originating from thermal decomposition of solids.

3. A process according to claim 1, further comprising directing at least an amount of the deoxygenated intermediate or the dearomatized intermediate to contact a material catalytically active in hydrocracking under hydrocracking conditions in the presence of dihydrogen, to provide a hydrocracked intermediate.

4. A process according to claim 2, further comprising the step of separating the dearomatized intermediate, in at least a high boiling fraction boiling above 300° C., and a vapor fraction and directing at least an amount of the high boiling fraction to contact the material catalytically active in hydrocracking under hydrocracking conditions in the presence of dihydrogen, to provide a hydrocracked intermediate.

5. A process according to claim 4, wherein the step of separating the deoxygenated intermediate involves stripping the deoxygenated intermediate with a stripping medium, at a temperature above 150° C., and a difference from the hydrodeoxygenation conditions being less than 10 bar.

6. A process according to claim 4, wherein separating the intermediate provides at least a heavy fraction boiling above a boiling point limit being 320° C., and a middle distillate fraction boiling above 150° C., and below the heavy fraction, and wherein the amount of the deoxygenated intermediate directed to contact a material catalytically active in hydrodearomatization under hydrodearomatization conditions in the presence of dihydrogen comprises at least an amount of the middle distillate fraction.

7. A process according to claim 6 wherein at least an amount of the heavy fraction is directed to one or more of the following: to contact the material catalytically active in hydrocracking under hydrocracking conditions in the presence of dihydrogen thereby providing a hydrocracked heavy product, to said thermal decomposition process thereby providing a decomposed heavy product as part of said feedstock or unstabilized feedstock or to be withdrawn as a heavy product, optionally for further treatment.

8. A process according to claim 6, wherein the mass of the heavy fraction is less than 15% of the feedstock.

9. A process according to claim 1, wherein one or more liquid recycle loops are established by directing an amount or a combination of amounts of middle distillate, dearomatized middle distillate, hydrocracked product, heavy fraction, hydrocracked intermediate, dearomatized intermediate or product stream to an upstream process step.

10. A process according to claim 1, where hydrodearomatization conditions involve a temperature in the interval 200-350° C., a pressure in the interval 30 Bar to 200 Bar, and a liquid hourly space velocity (LHSV) in the interval 0.5-8.

11. A process according to claim 1, wherein said material catalytically active in hydrodearomatization comprises an active metal taken from the group comprising platinum, palladium, nickel, cobalt, tungsten and molybdenum, and a refractory support.

12. A process according to claim 1, where the material catalytically active in hydrodearomatization has a higher hydrogenation activity than the material catalytically active in hydrodeoxygenation.

13. A process according to claim 1, where the stream directed to contact the material catalytically active in hydrodearomatization is cooled prior to contacting the material catalytically active in hydrodearomatization.

14. A process plant for conversion of a feedstock containing at least 5 wt % aromatics, originating from thermal decomposition of solids, comprising
a. a hydrodeoxygenation section containing a material catalytically active in hydrodeoxygenation operating under hydrodeoxygenation conditions in the presence of dihydrogen, having an inlet and an outlet,
b. a hydrodearomatization section containing a material catalytically active in hydrodearomatization operating under hydrodearomatization conditions in the presence of dihydrogen, having an inlet and an outlet,
wherein the outlet of the hydrodeoxygenation section is in fluid communication with the inlet of the hydrodearomatization section.
